(19) United States
(12) Patent Application Publication
(10) Pub. No.: US 2003/0005977 A1
(43) Pub. Date: Jan. 9, 2003

(54) Tree delimber and debarker and method

(76) Inventor: Charles Tapscott, Scottsville, VA (US)

Correspondence Address: Bryan D. Wright, Suite 300, 250 W. Main St., Charlottesville, VA, 22902, US

(21) Appl. No.: 10/114,013

(22) Filed: Mar. 29, 2002

Related U.S. Application Data
(60) Provisional application No. 60/279,556, filed on Mar. 29, 2001.

(51) Int. Cl. B27M 3/00; A01G 23/095; B27L 1/00; B27L 1/05; B27L 1/06; B27L 1/08; B27L 1/10; B27L 1/12; B27L 1/14; B27L 3/00

(52) U.S. Cl. 144/341; 144/343; 144/208.7; 144/24.13

(57) ABSTRACT

An apparatus which delimbs and debarks one or multiple tree stems which are fed into the apparatus by a circle loader by its boom arm and claw. The tree stem(s) are pulled through the apparatus by the circle loader as the apparatus delimbs and debarks the tree stems with a flail means of various designs and configurations. The flail means if further designed to eject material striped from the tree stems in a controlled fashion from the apparatus. Other safety features contain and prevent uncontrolled ejection of material striped from the tree stems. The flail means is further designed to assist the tree stem feeding by frictionally moving the tree stems into the apparatus with the action of one of the flail drums; and thus reducing wear and tear on the circle loader. The expanse of the feeding opening is designed to accommodate larger diameter and more numerous tree stems resulting in more efficient, faster, and safer delimbing and debarking.

### RELATED U.S. PATENT APPLICATION DATA

Applicant claims priority for this application to U.S. Provisional Application No. 60/279,556 filed on Mar. 29, 2001.

### FIELD OF THE INVENTION

The invention described herein generally relates to a mechanical tree delimber and debarker and method of its use. More specifically, the invention is a vehicle mounted or trailer mounted flail apparatus used to delimb and debark single or multiple trees and is specially designed to be used with a conventional circle loader.

### DESCRIPTION OF THE RELATED ART

In the timber industry, the use of flail machines to debark or delimb cut trees is well known. The usual method to debark or delimb trees after cutting is to pass them through a delimbing or debarking machine either singularly or several at a time, rendering the trees bare of bark and limbs for loading onto trucks and further processing. The use of flails, such as chains or cables, have been well known in the art for some years. For example, the machine disclosed in U.S. Pat. No. 2,713,365 (Jul. 19, 1955) discloses an upper and lower flail cylinder to which flails are attached and between which single trees are fed. Similarly, U.S. Pat. No. 2,822,837 discloses a debarker using three flail cylinders to which bristles are attached. Two such cylinders are parallel and vertical and the third horizontal, positioned above and perpendicular to the other two cylinders. A single tree is then fed through the three flail cylinders for processing. Another debarking and delimbing flail apparatus is disclosed by U.S. Pat. No. 4,640,325, which uses a feed mechanism to feed one tree between two horizontal and parallel flail drums, one above and one below. Other debarker and delimbers using a flail apparatus which are limited to the processing of a single log at a time are U.S. Pat. No.'s 4,738,292; 5,193,597; 5,249,613; 4,889,169; 5,349,999; 4,719,950. Other types of debarkers and delimbers using flail apparatuses are designed to be used with a skidder which may drag a single or a plurality of tree stems through the apparatus. For example, refer to U.S. Pat. No. 4,787,431; 4,903,744; and 4,711,280. U.S. Pat. No. 5,862,846 discloses a delimber and debarker using a flail apparatus of two parallel horizontal flail drums between which multiple tree stems may be passed. Also, disclosed is a feed arm for use on the apparatus for feeding the tree stems into the flail mechanism. Like the invention disclosed herein, a circle loader is used to feed the trees through the delimbing and debarking machine. U.S. Pat. No. 4,711,280 also discloses a flail mechanism containing two vertical and parallel flail drums through which multiple trees may be processed and fed by a circle loader.

Certain limitations and problems arise when using machines currently in the market and disclosed in the referenced patents. Current systems are limited in the number of trees which can be accommodated by their feed system or mechanism. Moreover, conventional machines have to be stopped and cleaned of debris periodically in order to continue the log processing process. Often, conventional machines do not completely remove the limbs or bark to yield a clean log in no further need of additional rough processing.

Further, openings through which trees are fed often allow stripped material to become projectiles as it is stripped from the trunk, a serious safety concern.

Moreover, conventional delimbers and debarkers are not designed to be used with a circle loader such that if they are so used with the circle loader the difficult and awkward angles (through which the circle loader must feed the tree stems) resulting from configuration of the delimber creates great strain and wear and tear on the circle loader boom and mechanisms. This causes circle loaders to wear out quickly, adding to the expense of the delimbing and debarking process.

### SUMMARY OF THE INVENTION

The present invention provides a compact delimbing and debarking device designed to be used with a circle loader on site where the trees are being felled. The system is designed to reduce wear and tear on the circle loader and provide more efficient and faster operation than conventional machines. Moreover, the present invention allows for larger and more trees to be processed into logs even while doing a more complete job of delimbing and debarking than conventional machines and in a safer environment for workers wherein potential ejected material stripped from the stems is controlled..

It is an object of the invention to provide a compact system, easily transportable by conventional means or by mounting on a vehicle. The width and other dimensions of the entire delimbing system are designed to comply with FTC regulations governing the trailering or transport of such machinery on the public highways. The system does not have protruding arms such as disclosed in U.S. Pat. No. 5,862,846 nor does it have protruding feed mechanisms as some other conventional debarker and delimbers. Its compact design allows it to be easily placed on a vehicle or on a trailer to be moved to the site where trees are being felled and logs produced.

Another object of the invention is to provide the ability to process larger diameter trees and more tree stems in one processing pass. To overcome the limitation of the current machines of the number of trees which can be processed at once, the disclosed device provides for more flails which results in more efficient debarking and delimbing. A wider distance than conventional machines between the flail drums to allow up to 10 to 12 trees (depending on their diameters) to be debarked and delimbed at one time. Embodiments of the present invention provide for tri-directional delimbing (so that the tree stems are flailed from three directions) which improves the speed of the delimbing process as well as the completeness of the delimbing or debarking process. Not only are all sides of the tree stem delimbed and debarked, it is accomplished faster and more efficiently than conventional devices and processes. It has been determined that the disclosed invention can delimb and debark up to three times faster than conventional systems which wear circle loaders out in approximately 24 months.

Another object of the invention is to improve the safety for workers working in the area of the delimber. Controlling the ejection of debris becomes important for the safety of the workers onsite. Embodiments of the disclosed machine provide for a horizontal drum flail which turns in the same direction as the trees are fed. Thus, the bottom flails as they spin upward toward the tree stems clean out the debris from the trough below the horizontal flail drum and eject it in a controlled fashion back out of the loading point of the trees in the opposite direction that the trees are being loaded. Thus, the tree stems and tree limbs provide buffers for ejected material.

Another important safety innovation on some embodiments is the offset roof and neck through which the tree stems are loaded. The configuration of the offset roof and neck provides a complete encasement of the tree stems as they are processed. This precludes ejection of debris out the loading neck unlike any conventional delimbing or debarking machine. The configuration of the loading neck also precludes a necessity for loading arms and feeding mechanisms which protrude beyond the footprint of the disclosed machines. The disclosed machines are compact in width and length allowing for easy fixing atop a vehicle or easy trailering to job sites. Also, an important aspect of embodiments of the disclosed invention is the angled roof and feed neck configuration which enables faster tree stem feeding which increases speed of production of logs.

As another safety aspect, one embodiment of the disclosed invention provides for a level feed arm with a hydraulically controlled push arm which feeds tree stems into the delimber throat. The push arm, once closed, completely encapsulates the tree stems so that no tree stem can escape from the delimber as the process continues. Another embodiment with the angled roof also provides the same safety for workers. All embodiments of the disclosed invention have large open throats which enable trees with larger diameters and more multiple stems to be delimbed in one fast motion than conventional delimbers and debarkers.

Additional safety features for the protection of the operator of the circle loader and other works in the area are a controllably hinged roof above the feed opening through which the tree stems are fed and a controllably hinged door at the opening through which the processed tree stems emerge. The roof and door present physical barriers limiting the ejection of stripped material during the operation of the machine. The door particularly limits ejection of stripped material toward the operator of the circle loader.

Another object of the invention is to provide a delimber with a longer life and less maintenance. The disclosed invention, although which may be powered with conventional belts and pulleys, also discloses that the flail drums may be hydraulically driven providing smoother operation as well as longer and more reliable service. Thus, the disclosed invention requires less maintenance and has a longer life than conventional delimber and debarker machines.

Yet another object of the invention is to reduce the stress and wear and tear on the circle loader's boom arm and mechanisms. In one embodiment of the disclosed invention, the horizontal flail drum helps force the tree stems through the system providing greater speed and efficiency in the debarking and delimbing process, thus reducing the cost of the process, as well as assisting the circle loader as the tree stems go through the machine. Thus, there is less wear and tear on the circle loader. Less stress on the circle loader is also accomplished by using the offset angled roof and feed throat configuration which allows for a natural motion of a circle loader as it passes the tree stems, which are pivoted on their tops, through the disclosed machine. Further to assist in reducing resistence as the tree stems go through the machine is a third flail mechanism which assists in pushing the tree stems through the machine in addition to delimbing and debarking the upper portion of the tree stem.

Other objectives, advantages, and pertinent features of the present invention will become apparent from the following detailed description, which when taken in conjunction with the drawings attached, discloses several preferred embodiments of the present invention.

### BRIEF DESCRIPTION OF THE DRAWINGS

The invention will be described in detail hereunder with reference to the accompanying drawing figures wherein;

FIG. 1 shows a perspective view of the disclosed invention (tree delimber and debarker), the circle loader, a pile of cut trees ready for processing, several tree stems being loaded into the disclosed invention, and a pile of processed logs;

FIG. 2 shows a schematic view of the hydraulic drive system which may be used for each disclosed embodiment;

FIG. 3 shows a top view of the flail drum configurations as well as the angled offset roof and open throat configuration of the first preferred embodiment of the disclosed invention;

FIG. 4 shows a side view of the flail drum configuration and the angled offset roof and open throat configuration of a preferred embodiment of the invention;

FIG. 5 shows a cross sectional view of the drum configuration of a preferred embodiment of the invention;

FIG. 6 shows a side view of the flail drum configuration and open feed throat configuration of a preferred embodiment of the disclosed invention;

FIG. 7 shows a top cross sectional view of a preferred embodiment of the disclosed invention;

FIG. 8 shows a top view of the configuration of the flail drums in a preferred embodiment of the disclosed invention;

FIG. 9 shows a cross sectional rear view of the configuration of the flail drums used in a preferred embodiment of the disclosed invention;

FIGS. 10, 11, and 12 show a side view of another preferred embodiment of the disclosed invention.

FIG. 13 shows a cutaway view of the three drum flail mechanism of a preferred embodiment.

FIG. 14 shows a side view of the invention with controllably hinged roof portion and door portion in open positions.

FIG. 15 shows a side view of the invention with the controllably hinged roof and door in closed positions.

FIG. 16 shows a cutaway view of the invention with the controllably hinged roof and door.

### DETAILED DESCRIPTION OF THE INVENTION

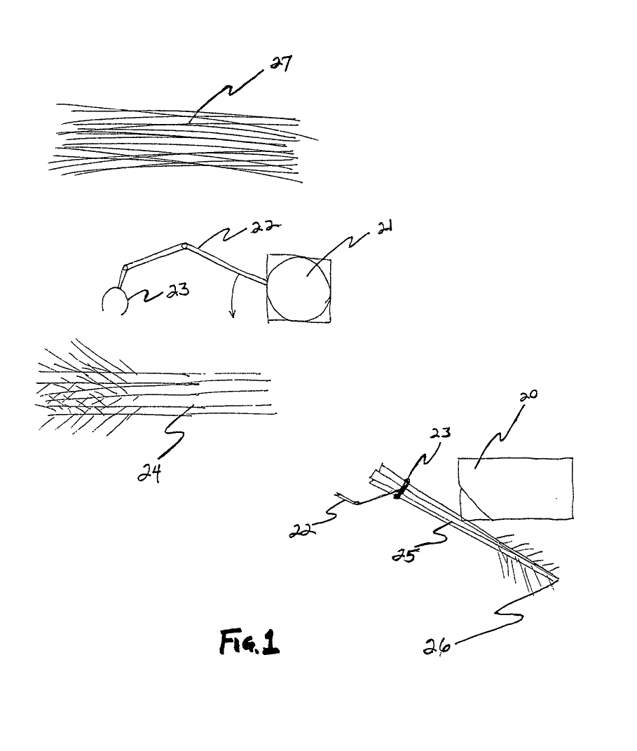

As shown in FIG. 1 the disclosed invention (tree delimber and tree debarker) 20 is designed to be used in connection with a circle loader 21 having a boom arm 22 and a claw 23 able to grasp, pick up, and move one or a plurality of tree stems. The freshly cut tree stems are skidded or otherwise placed in a pile 24 in proximity to the circle loader 21 and the delimber 20. The logs are processed by the circle loader 21 grasping one or a plurality of freshly cut tree stems with its claw 23 from tree pile 24 and moving in a circular motion toward the delimber 20. The tree stems 25 which are in the claw 23 are moved by the boom arm 22 of the circle loader 21 and placed into the delimber 20. The natural mechanical motion of the circle loader 21 allows the tree stems 25 to pivot on their tops 26, continuing the motion of the boom arm 22 in a circular direction. The tree stems 25 after going through the delimber 20 are then placed in a pile of cleaned logs 27. These logs 27 are ready for delivery to the lumber mill. The process is designed to provide the most efficient and fastest use of a circle loader for the processing of tree stems. As described below, the delimber 20 is designed to push the tree stems through the process and thereby assist the circle loader causing less wear and tear on the circle loader and conventional systems.

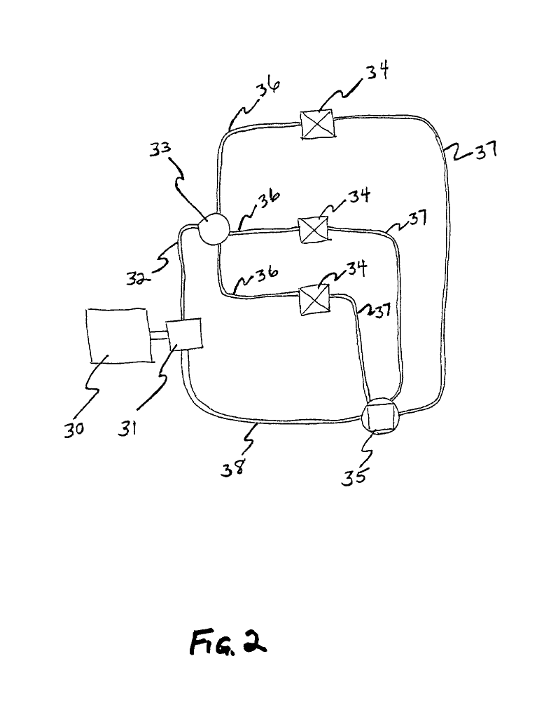

Shown in FIG. 2 is a schematic of a hydraulic drive system for the flail drums depicted in the other attached drawings. Although the disclosed invention may be powered by conventional belt and pulley systems, the powering of the flail drums by a hydraulic system provides smoother operation, more reliable processing and less frequent service and maintenance. Thus, the use of a hydraulic power system reduces the cost of overall tree processing. The hydraulic system disclosed shows an engine 30, being one of a number of diesel engines or other internal combustion engines such as a General Motors 240 horsepower diesel engine. The engine 30 is mechanically connected to a hydraulic pump 31 which forces hydraulic fluid through the hydraulic line 32 to a directional valve 33. The directional valve 33 directs the hydraulic fluid through the hydraulic lines 36, 36a and 36b to hydraulic motors 34, 34a, and 34b. Each of the hydraulic motors 34, 34a and 34b is operationally connected to a flail drum (e.g. 42, 40, 40a). Hydraulic motor 34, 34a, and 34b are powered by the hydraulic fluid which is then directed through the hydraulic lines 37, 37a and 37b to the oil cooler 35. From the oil cooler, the hydraulic fluid is directed through the hydraulic line 38 back to the hydraulic pump 31 to be recirculated.

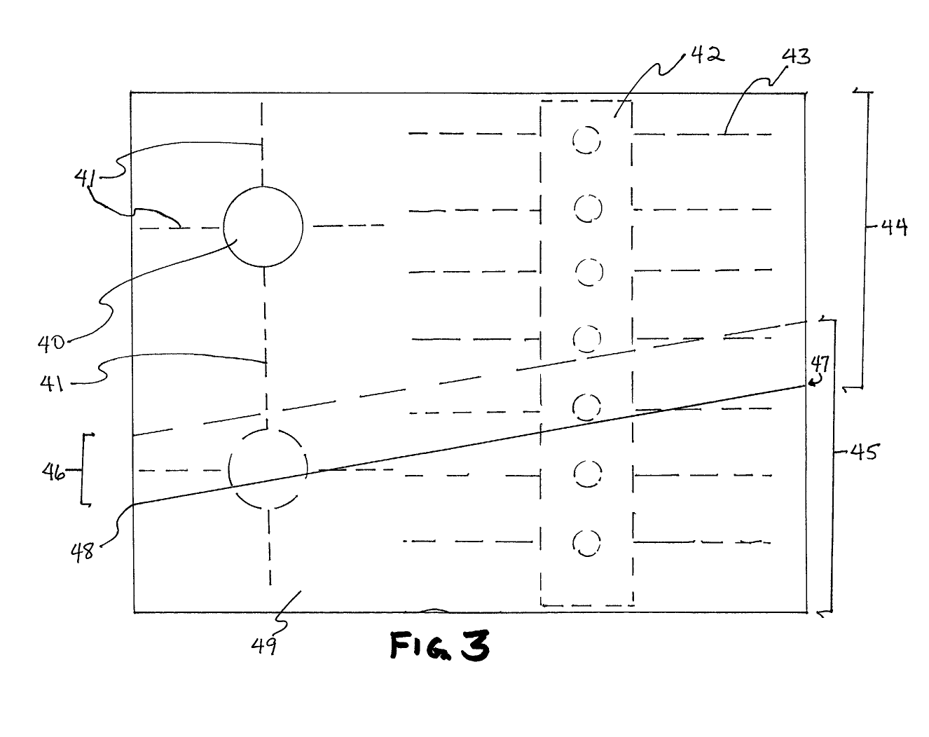

FIG. 3 shows a top view of the rear portion of a preferred embodiment detailing two vertical parallel flail drums 40 and 40a each having a plurality of flails 41 removably attached along the perimeter of each drum in any one of various densities and configurations. The flails 41 may be composed of chain, cable, bristles, or other material of sufficient strength to beat the bark and limbs off of the tree stems 25(FIG. 1). Positioned below and offset to the vertical flail drums 40 is a horizontal flail drum 42 which likewise has attached flails 43 along its perimeter. The roof which is shown in perspective view 44 shows to overlap the rear portion of the base 45 and is angled at the same angle as the edge of the base to point 48. The overlap 46 of the roof 44 over the rear portion of the base 45 becomes a critical element in the feeding of tree stems 25 (FIG. 1) by the circle loader for both the safety of workers in the area by containing ejected debris and in reducing wear and tear on the circle loader 21 by allowing a more natural motion of the circle loader in feeding the tree stems. Tree stems 25 (FIG. 1) are fed by the circle loader claw 23 (FIG. 1) by pivoting the top of the trees at pivot point 26 (FIG. 1) and guiding the tree stems between the overhang and the roof 44 and the rear of the base 45 at 47. Horizontal drum 42 is turned by the power system in the same direction as the trees are being fed thus assisting the trees to move between vertical drums 40 and 40a. This assistance also reduces stressful forces on the boom arm 22 (FIG. 1) increasing longevity of operational life to the circle loader 21.

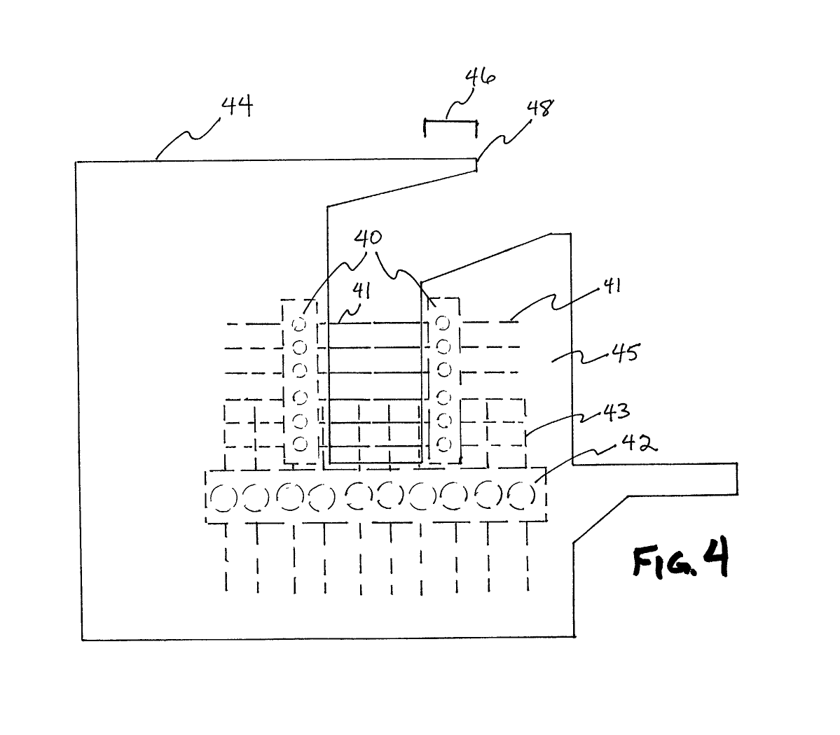

FIG. 4 shows a side perspective view of a preferred embodiment of the disclosed invention. This perspective shows the two vertical flail drums 40 and the offset horizontal drum 42 each having removably attached a plurality of flails 41 and 43. The overlap 46 of the roof 44 over the rear edge portion of the base 45, helps contain ejected debris as trees are processed.

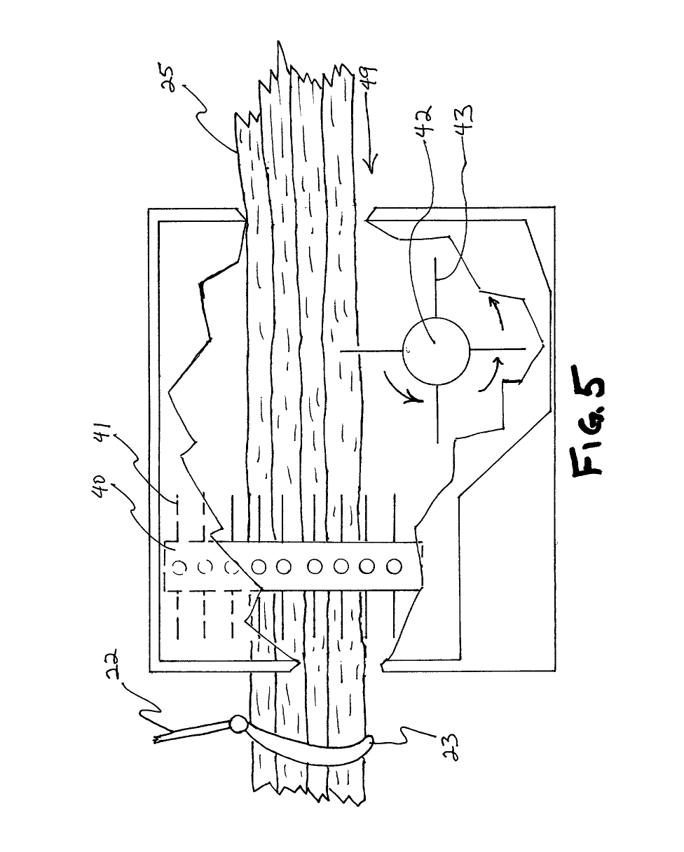

FIG. 5 shows a cross sectional perspective view of the configuration between the rearmost vertical drum 40 and the horizontal drum 42 both having removably attached flails 41 and 43. The tree stems 25 (FIG. 1) are put through the machine by the claw 23 (FIG. 1) attached to the boom arm 22. The direction of the trees is shown as direction 49. The horizontal drum is turned in the same direction as the trees are fed (shown by the arrows), thus assisting the trees as they pass between the rearmost vertical drum 40 and its mirror image. The flails 43 removably attached to horizontal drum 42 move in the direction shown by the arrows and scrape the bottom of the trough below the horizontal drum thus cleaning the debris taken from the tree trunks and ejecting it in a controlled fashion back in the direction from which the trees 25 are being fed.

FIG. 6 shows a cross sectional perspective view of a preferred embodiment of the invention. This figure shows a long vertical flail drum 50 to which a plurality of flails 51 are removably attached. Parallel to drum 50 is a second shorter vertical drum 52 to which a plurality of flails 52 are removably attached. The distance between the axes points of the parallel flail drums 50 and 52 can range from 36 inches to 52 inches, allowing the processing of larger diameter and more numerous tree stems in a single processing pass. The distance between the axes of these vertical parallel flail drums may be adjustable. Also shown is a bottom drum 54 which is below horizontal and offset to the two parallel vertical drums 50 and 52. It 54 has removably attached a plurality of flails 55. In one embodiment is a fourth flail drum 56 to which is removably attached a plurality of flails 57. Each of the drums is attached to and powered by a hydraulic motor 34, two of which are shown on FIG. 6. The overlap 46 of the roof over the rear edge of the base of the disclosed invention 45 provides barriers to the stripped material which would otherwise be ejected. Flail drum 56 is obliquely positioned in relation to the bottom drum 54 and when in motion, by the action of the flails 55 against the tree stems 25 (FIG. 1), assists in forcing the trees through the open throat and between the vertical flail drums 50 and 52. Flail drum 56 and its flails 57 also assist in preventing the escape of ejected debris, improving the safety discussed above. Furthermore, drum 56 and its flails 57 assist in improving the efficiency and speed of operation of a tree stem 25 processing pass thus cutting the cost of log processing with the disclosed invention. Also shown is a conventional trailer tongue 59 designed to be used in connection with any conventional tractor or other pulling vehicle. Also shown is one of two telescoping adjustable legs and feet 58 at the tongue 59 end of the trailer unit. These legs 58 are located and adjustably attached one on each side of the device and may be operated independently either mechanically or hydraulically. Said legs 58 provide stability of the machine in the field either after the removal of the trailering vehicle or of the vehicle upon which the delimber system may be mounted.

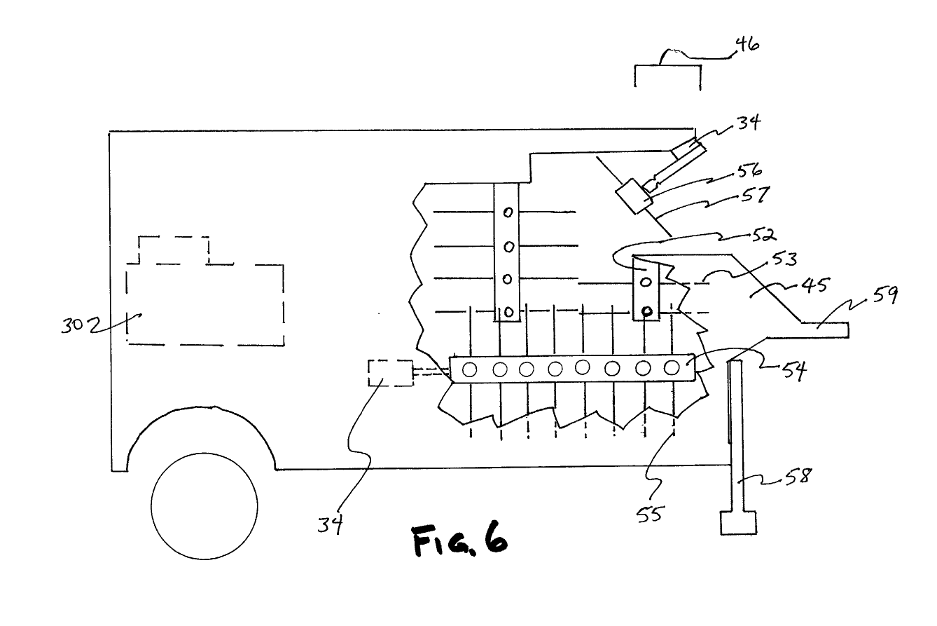

FIG. 7 shows a pile of tree stems 24 with a tree stem 25 being put through the delimber. The top cross sectional view of the disclosed a preferred embodiment is shown with the long vertical drum 50 parallel to the short vertical drum 52 and offset to the horizontal drum 54. Also shown is the small upper most flail drum 56 obliquely angled to horizontal flail drum 54. The flails 57 on flail drum 56 act as described above mechanically moving the tree stem through the delimber system, resulting in reduced stress on the circle loader 21.

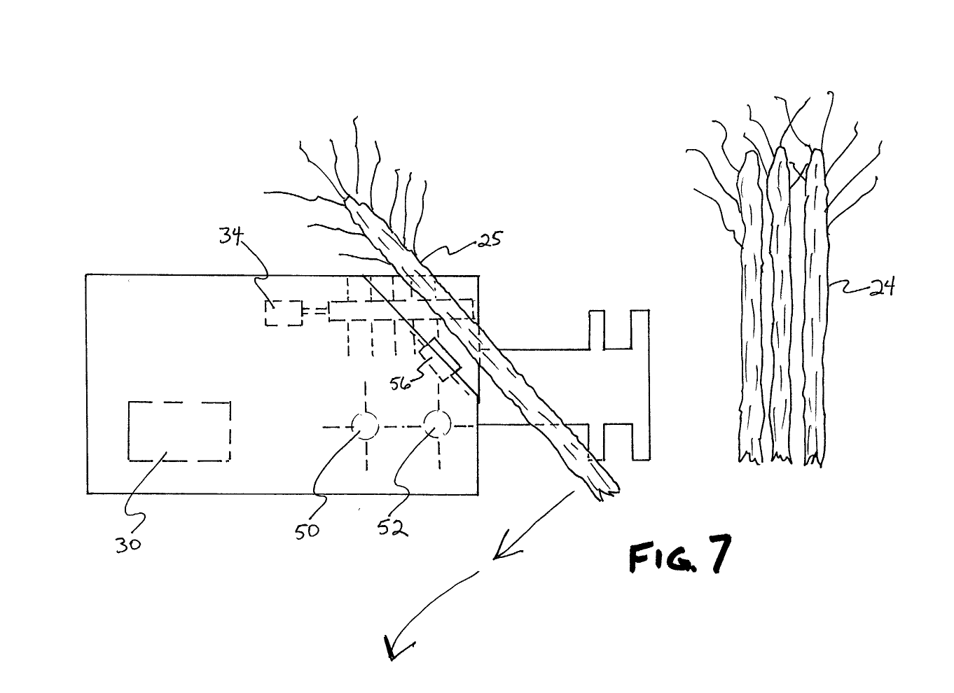

FIG. 8 shows the configuration of these four flail drums in the second preferred embodiment. The small upper most flail drum 56 is shown in relation to the small vertical flail drum 52, the long vertical drum 50, and the horizontal flail drum 54. This is a top view looking down in cross section.

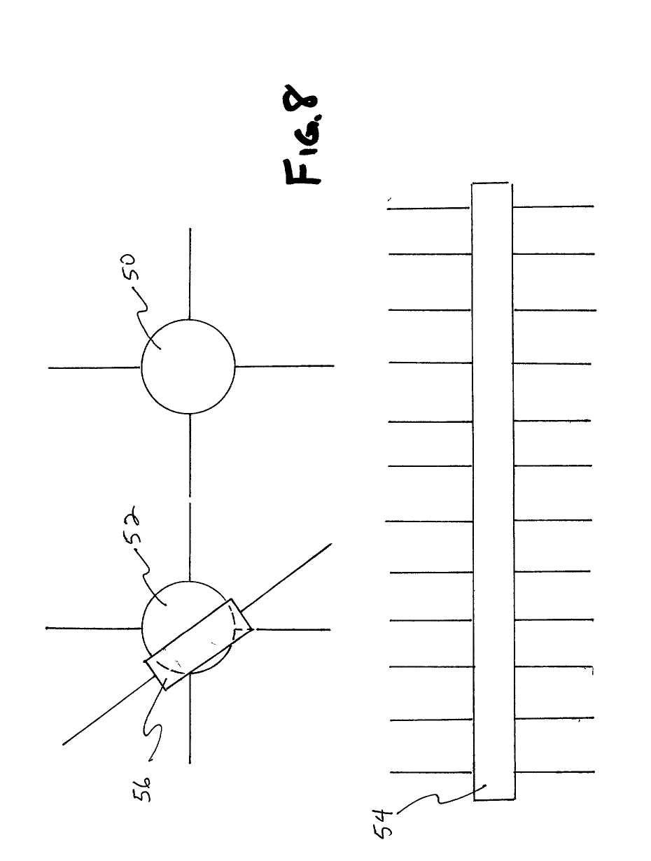

FIG. 9 shows a side view of the five flail drums of the second preferred embodiment. The small upper most flail drum 56 is shown in relation to the short vertical flail drum 52, the long vertical flail drum 50 and the horizontal flail drum 54.

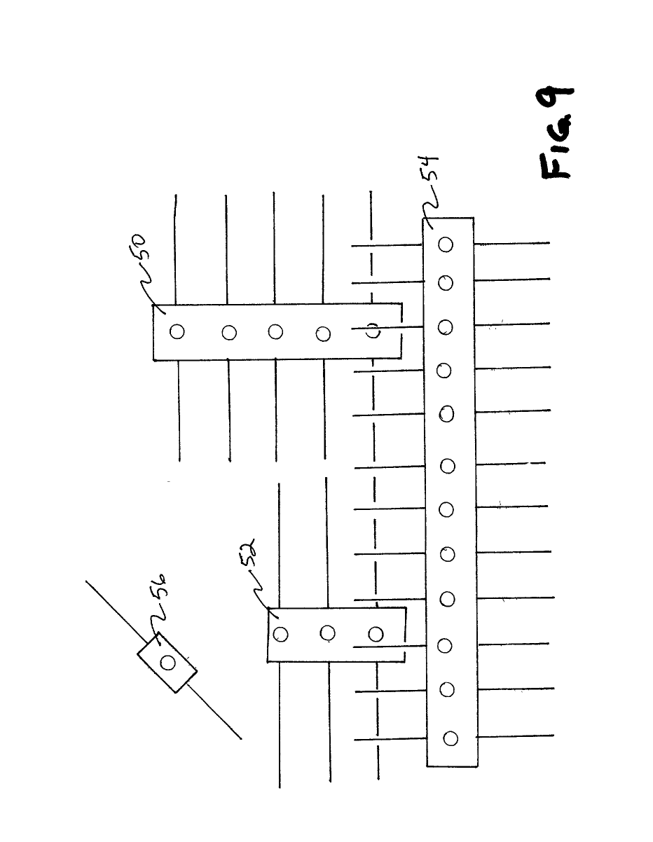

FIG. 10 shows the delimber 20 having a roof portion 70 hingedly attached to the remaining roof portion 78. Said roof portion 70 having two opposite sides to which there is fixedly attached a side portion 71 and 79.

To the bottom edge of said side portions 71 and 79, there are attached containment chains 73. The roof portion 70, in its closed position, rests on the lip 81 of the tongue 59 end of the delimber 20. The roof portion 70 may be mechanically or hydraulically opened in the direction of the arrow and tree stems 25 placed through the flail mechanism. The disclosed flail mechanism has two vertical and parallel flail drums 74 and 75 and an offset horizontal drum 76 all of which have removably attached flails 77.

FIG. 11 shows the roof portion 70 which is hingedly attached to roof portion 78 in the closed position. Side portion 71 of roof portion 70 may be seen to which are attached containment chains 73.

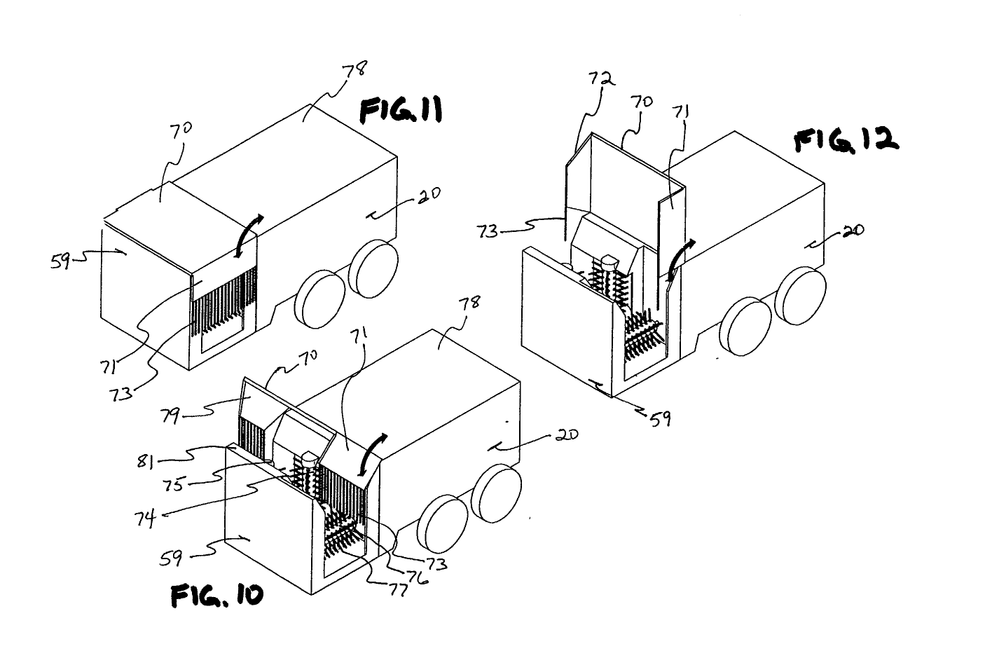

FIG. 12 shows the roof portion 70 in a more open condition so that the sides 71 and 72 of roof portion 70 can be seen. In this open condition, tree stems 25 may be placed through the flail mechanism by the circle loader 21.

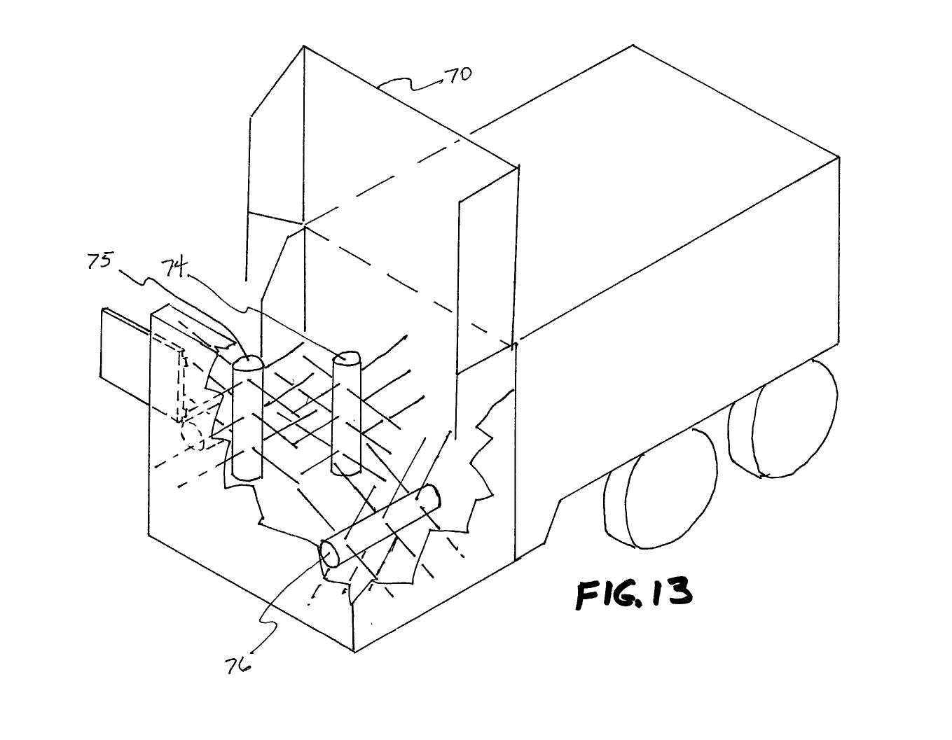

FIG. 13 discloses a cut-away view of the flail mechanism of a preferred embodiment showing the roof portion 70 in an open position. Horizontal flail drum 76 can be seen in proximity to vertical and parallel flail drums 74 and 75.

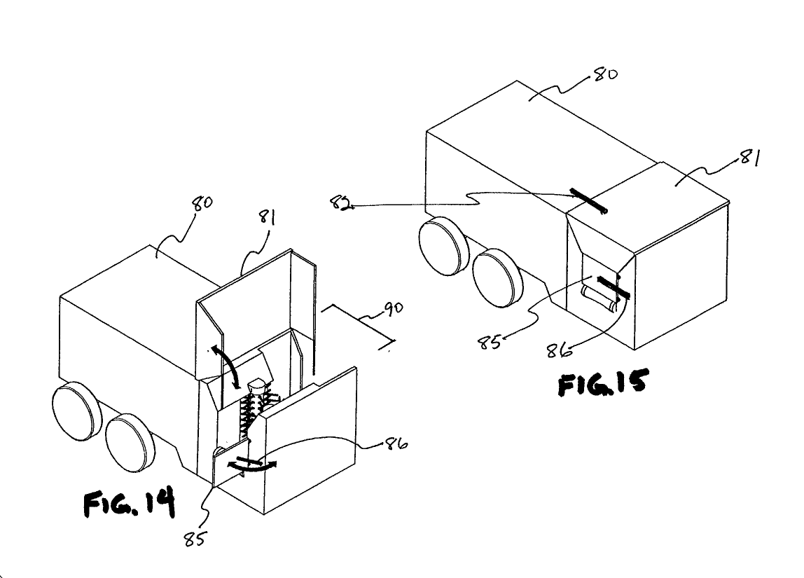

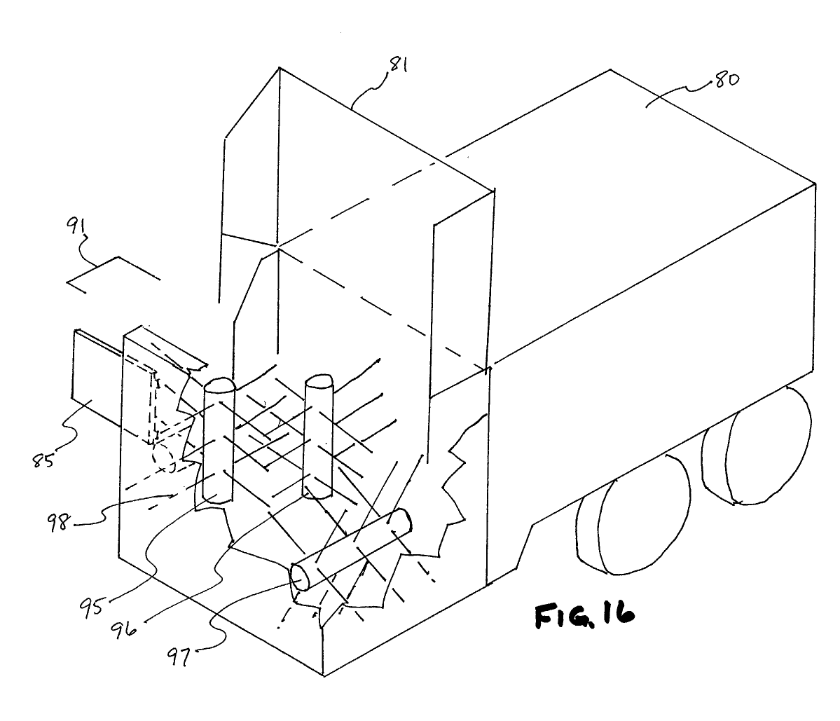

An embodiment shown in FIGS. 14, 15, and 16 contain certain safety features. Roof portion 81 is hingedly and controllably attached to roof portion 80. Roof portion 81 may be lifted and lowered controllably by a hydraulic cylinder 82 or other mechanical or spring means. Tree stem exit door 85 likewise is hingedly attached to the delimber body and controllably operated by a hydraulic cylinder 86 or other mechanical or spring means. Roof 81 is lifted as the circle loader 21 inserts unprocessed tree stems 25 into the feed opening 90. Door 81 is then closed, preferably by remote operation. Exit door 85 is open as the tree stems are drawn through the flail mechanism. Door 85 rides against the tree stems as they emerge from the delimber. Upon the clearing of the delimber by the processed tree stems, the door 85 continues to the closed position (FIG. 15) while the flail means of the machine continues to spin. The roof 81 at all times during the operation of the machine after the loading of tree stems 25 is kept in its closed position. Roof 81 presents a physical barrier for the ejection of material stripped from the tree stems 25 by the flail mechanism. Door 85 presents a physical barrier between the circle loader and the delimber which protects the circle load operator and other workers in the area from ejected stripped material. Feed opening 90 is wide enough to accommodate multiple tree stems or large diameter tree stems. The processed tree stems emerge from opening 91 which is covered by door 85 when in its closed position. The flail mechanism is comprised of two vertical parallel flail drums 95 and 96, each having a plurality of flails 98 removably attached along the perimeter of each drum in any one of various densities and configurations. Positioned below and offset to the vertical flail drums 95 and 96 is horizontal flail drum 97 which likewise has attached flails 98 along its perimeter. Flail drum 95 turns in a clockwise direction while flail drum 96 rotates in a counterclockwise direction when looking from overhead. These opposite rotations of flail drums 95 and 96 serve to eject stripped material through feed opening 90, the direction from which the tree stems were fed. Horizontal flail drum 97 may be turned in either direction. When turned in the same direction as the tree stems are fed, horizontal flail drum 97 serves to frictionally move the tree stems through the delimbing mechanism. This serves to save wear and tear on the circle loader. When horizontal flail drum 97 turns in the opposite direction from which the tree stems are fed, it serves to clear the bottom of the flail means of material stripped from the tree stems. In either direction, said horizontal flail drum 97 serves to assist in ejecting the stripped material through opening 90 in a controlled fashion thus maintaining safety for area workers and keeping the area of the flail mechanism clean of debris.

What is claimed is:

1) An apparatus for debarking and delimbing one or a plurality of tree stems comprising:
a flail means comprising a horizontal flail drum and two vertical parallel flail drums, each of said flail drums having a series of flails extending radially outward from the axis of each of said flail drums, said horizontal flail drum being fixed at a location to receive on its top the tree stem(s) forward of but with its top not lower than the bottom of said vertical parallel flail drums, said vertical parallel flail drums located at a position behind said horizontal flail drum;
a containment means for controlling the ejection of material striped from the tree stem(s) by said flail means.

2) A method for delimbing and debarking one or a plurality of tree stems comprising:
felled tree stems which are provided;
a circle loader with boom arm and claw for grasping one or a plurality of tree stems is also provided;
an operator of the circle loader which is provided;
and wherein the circle loader feeds one or a plurality of tree stems through the apparatus described in claim 1.
